(19) United States
(12) Patent Application Publication
(10) Pub. No.: US 2026/0249266 A1
(43) Pub. Date: Aug. 27, 2026

(54) REFORMING DEVICE

(71) Applicant: KABUSHIKI KAISHA TOYOTA JIDOSHOKKI, Kariya-shi, Aichi (JP)

(72) Inventors: Hiroyasu KAWAUCHI, Kariya-shi, Aichi-ken (JP); Hidehito KUBO, Kariya-shi, Aichi-ken (JP); Hideaki SUZUKI, Kariya-shi, Aichi-ken (JP); Shohei MATSUMOTO, Kariya-shi, Aichi-ken (JP); Norinosuke NAKATANI, Kariya-shi, Aichi-ken (JP)

(73) Assignee: KABUSHIKI KAISHA TOYOTA JIDOSHOKKI, Kariya-shi, Aichi (JP)

(21) Appl. No.: 18/578,266

(22) PCT Filed: May 24, 2022
(86) PCT No.: PCT/JP2022/021297

§ 371 Date: Jan. 10, 2024

(30) Foreign Application Priority Data
Jul. 13, 2021 (JP) 2021-115583

(51) Int. Cl. B01J 19/24; B01J 19/00; C01B 3/047

(52) U.S. Cl. CPC B01J 19/244; B01J 19/0013; C01B 3/047; B01J 2219/00157; B01J 2219/1943

(57) ABSTRACT

A reforming device includes: an outer cylinder; an inner cylinder; a combustible gas introduction part; and an igniter. A tubular combustible gas passage through which fuel gas and oxidized gas introduced by the combustible gas introduction part flow toward a front end of the outer cylinder is formed between the outer cylinder and the inner cylinder. The front end of the outer cylinder is provided with a front closure wall that closes a space in the outer cylinder. A rear end of the outer cylinder is provided with a rear closure wall that closes the tubular combustible gas passage. The combustible gas introduction part is located near the rear end of the outer cylinder and introduces the fuel gas and the oxidized gas to the tubular combustible gas passage so that the fuel gas and the oxidized gas flow in a circumferential direction of the inner cylinder.

### TECHNICAL FIELD

The present invention is related to a combustor and a reforming device.

### BACKGROUND ART

Patent Literature 1 mentions a tubular flame burner serving as a combustor, for example. The tubular flame burner in Patent Literature 1 includes: a tubular combustion chamber having an open end; a nozzle for spraying fuel gas and oxygen-containing-gas to the combustion chamber; a spark plug for igniting the fuel gas; an outer cylinder having a closed distal end and covering the combustion chamber; a pipe connected to the distal end of the outer cylinder and supplying the fuel gas and the oxygen-containing-gas to a space formed by the combustion chamber and the outer cylinder; and a pipe connected to a rear end of the outer cylinder and introducing the fuel gas and the oxygen-containing-gas preheated in the space formed by the combustion chamber and the outer cylinder to the nozzle. The nozzle is disposed in a neighborhood of a tangential direction of the inner peripheral surface of the combustion chamber. The fuel gas and the oxygen-containing-gas are sprayed from the nozzle to form a swirl flow in the combustion chamber.

### CITATION LIST

### Patent Literature

Patent Literature 1: Japanese Patent Application Publication No. 2004-93118

### SUMMARY OF THE INVENTION

### Technical Problem

In this conventional art, the fuel gas and the oxygen-containing-gas are introduced by the nozzle in the neighborhood of the tangential direction of the inner peripheral surface of the combustion chamber to generate a swirl flow of the fuel gas and the oxygen-containing-gas (oxidized gas) in the combustion chamber. This complicates the nozzle configuration for generating the swirl flow of the fuel gas and the oxygen-containing-gas, thereby complicating manufacturing of the nozzle. This also complicates the pipe configuration for introducing the fuel gas and the oxygen-containing-gas, which has been heated by combustion heat in the combustion chamber, to the nozzle.

The present invention, which has been made in light of the above described problem, is directed to providing a combustor and a reforming device that have a simple configuration to generate a swirl flow of fuel gas and oxidized gas and heat the fuel gas and the oxidized gas.

### Solution to Problem

According to an embodiment of the present invention, a combustor for combusting fuel gas includes: an outer cylinder; an inner cylinder disposed radially inward of the outer cylinder; a combustible gas introduction part introducing the fuel gas and oxidized gas to the outer cylinder; and an igniter configured to ignite the fuel gas introduced to the outer cylinder, wherein the inner cylinder has a front end that is located between a front end of the outer cylinder and a rear end of the outer cylinder, the front end and a rear end of the inner cylinder are opened, a tubular gas passage through which the fuel gas and the oxidized gas introduced by the combustible gas introduction part flow toward the front end of the outer cylinder is formed between the outer cylinder and the inner cylinder, the front end of the outer cylinder is provided with a front closure wall that closes a space in the outer cylinder, the rear end of the outer cylinder is provided with a rear closure wall that closes the tubular gas passage, the igniter is fixed to the front closure wall, and the combustible gas introduction part is located near the rear end of the outer cylinder and introduces the fuel gas and the oxidized gas to the tubular gas passage so that the fuel gas and the oxidized gas flow in a circumferential direction of the inner cylinder.

In such a combustor, the fuel gas and the oxidized gas are introduced by the combustible gas introduction part to the outer cylinder, and flow in the tubular gas passage between the outer cylinder and the inner cylinder toward the front end of the outer cylinder. The fuel gas and the oxidized gas are introduced to the tubular gas passage so that the fuel gas and the oxidized gas flow in the circumferential direction of the inner cylinder, and the fuel gas and the oxidized gas therefore swirl and flow to the front end of the outer cylinder. The fuel gas is ignited by the igniter and burns, and the combustion gas flows in the inner cylinder (inside of the inner cylinder). The heat of the combustion gas heats the fuel gas flowing in the tubular gas passage (outside of the inner cylinder). The fuel gas ignites in this state, so that the combustion of the fuel gas is stabilized. In this way, the fuel gas and the oxidized gas flow in the tubular gas passage between the inner cylinder and the outer cylinder in the circumferential direction of the inner cylinder. Accordingly, this simple configuration allows the generation of the swirl flow of the fuel gas and the oxidized gas. Furthermore, the heat of the combustion gas flowing inside of the inner cylinder heats the fuel gas and the oxidized gas flowing outside of the inner cylinder. Accordingly, this simple configuration allows the heating of the fuel gas and the oxidized gas.

An axial positional relationship of the inner cylinder to the front closure wall may be defined so that the fuel gas and the oxidized gas introduced by the combustible gas introduction part to the tubular gas passage swirl and flow to the front closure wall. This allows the fuel gas to ignite while swirling so as to form a tubular flame. Additionally, this promotes the ignition of the fuel gas that has a slow combustion speed, thereby further stabilizing the combustion of the fuel gas.

The combustor may further include another gas introduction part that introduces at least one of cooling gas, fuel gas, and oxidized gas to the inner cylinder. According to this configuration, the cooling gas is introduced to the inner cylinder, so that the temperature of the combustion gas flowing in the inner cylinder decreases. The combustion gas is supplied downstream of the inner cylinder together with the fuel gas introduced to the inner cylinder, so that the temperature of the combustion gas flowing in the inner cylinder decreases. The combustion gas is supplied downstream of the inner cylinder together with the oxidized gas introduced to the inner cylinder, so that the combustion of the fuel gas is promoted.

The inner cylinder may have a protruding portion that protrudes from the rear end of the outer cylinder, and another gas introduction part may be disposed at the protruding portion. According to this configuration, the cooling gas or the fuel gas is introduced to the inner cylinder by this simple configuration.

According to another embodiment of the present invention, a reforming device for reforming fuel gas into reformed gas containing hydrogen by using heat generated by combusting the fuel gas includes: an outer cylinder; an inner cylinder disposed radially inward of the outer cylinder; a combustible gas introduction part introducing the fuel gas and oxidized gas to the outer cylinder; an igniter configured to ignite the fuel gas introduced to the outer cylinder; a catalytic part heated by the heat of combustion gas generated by ignition of the fuel gas by the igniter so as to combust the fuel gas and reform the fuel gas; and a gas supply part through which the fuel gas and the oxidized gas are supplied to the catalytic part, wherein the inner cylinder has a front end that is located between a front end of the outer cylinder and a rear end of the outer cylinder, the front end and a rear end of the inner cylinder are opened, a tubular combustible gas passage through which the fuel gas and the oxidized gas introduced by the combustible gas introduction part flow toward the front end of the outer cylinder is formed between the outer cylinder and the inner cylinder, the front end of the outer cylinder is provided with a front closure wall that closes a space in the outer cylinder, the rear end of the outer cylinder is provided with a rear closure wall that closes the tubular combustible gas passage, the igniter is fixed to the front closure wall, and the combustible gas introduction part is located near the rear end of the outer cylinder and introduces the fuel gas and the oxidized gas to the tubular combustible gas passage so that the fuel gas and the oxidized gas flow in a circumferential direction of the inner cylinder.

In such a reforming device, the fuel gas and the oxidized gas are introduced by the combustible gas introduction part to the outer cylinder, and flow in the tubular combustible gas passage between the outer cylinder and the inner cylinder toward the front end of the outer cylinder. The fuel gas and the oxidized gas are introduced to the tubular combustible gas passage so that the fuel gas and the oxidized gas flow in the circumferential direction of the inner cylinder, and the fuel gas and the oxidized gas therefore swirl and flow to the front end of the outer cylinder. The fuel gas is ignited by the igniter and burns, and the combustion gas flows in the inner cylinder (inside of the inner cylinder). The heat of the combustion gas heats the fuel gas flowing in the tubular combustible gas passage (outside of the inner cylinder). The fuel gas ignites in this state, so that the combustion of the fuel gas is stabilized. The fuel gas and the oxidized gas are supplied to the catalytic part through the gas supply part. The catalytic part combusts and reforms the fuel gas into the reformed gas containing hydrogen. In this way, the fuel gas and the oxidized gas flow in the tubular combustible gas passage between the inner cylinder and the outer cylinder in the circumferential direction of the inner cylinder. Accordingly, this simple configuration allows the generation of the swirl flow of the fuel gas and the oxidized gas. Furthermore, the heat of the combustion gas flowing inside of the inner cylinder heats the fuel gas and the oxidized gas flowing outside of the inner cylinder. Accordingly, this simple configuration allows the heating of the fuel gas and the oxidized gas.

An axial positional relationship of the inner cylinder to the front closure wall may be defined so that the fuel gas and the oxidized gas introduced by the combustible gas introduction part to the tubular combustible gas passage swirl and flow to the front closure wall. This allows the fuel gas to ignite while swirling so as to form a tubular flame. Additionally, this promotes the ignition of the fuel gas that has a slow combustion speed, thereby further stabilizing the combustion of the fuel gas.

The catalytic part may be accommodated in the inner cylinder. According to this configuration, the reforming device is reduced in size in the axial direction and therefore downsized.

The gas supply part may include a reforming gas introduction part introducing the fuel gas and the oxidized gas to the inner cylinder and a tubular reforming gas passage which is formed between the inner cylinder and the catalytic part and through which the fuel gas and the oxidized gas introduced by the reforming gas introduction part flow toward the front end of the inner cylinder. According to this configuration, the fuel gas and the oxidized gas introduced to the inner cylinder flow in the tubular reforming gas passage between the inner cylinder and the catalytic part toward the front end of the inner cylinder, and are supplied to the catalytic part. The fuel gas and the oxidized gas flowing in the inner cylinder are heated by the heat of the catalytic part and supplied to the catalytic part. This allows the catalytic part to effectively combust and reform the fuel gas.

The inner cylinder may have a protruding portion that protrudes from the rear end of the outer cylinder, and the reforming gas introduction part may be disposed at the protruding portion. According to this configuration, the fuel gas and the oxidized gas are introduced to the inner cylinder by this simple configuration.

### Advantageous Effects of the Invention

The present invention allows the generation of a swirl flow of fuel gas and oxidized gas and the heating of the fuel gas and the oxidized gas with a simple configuration.

### BRIEF DESCRIPTION OF THE DRAWINGS

FIG. 1 is a schematic diagram of a reforming system including a combustor-provided-reforming device serving as the reforming device according to a first embodiment of the present invention.

FIG. 2 is a plan view of the combustor-provided-reforming device illustrated in FIG. 1.

FIG. 3 is a sectional view of the combustor-provided-reforming device of FIG. 2, taken along the line III-III.

FIG. 4 is a sectional view of the combustor-provided-reforming device of FIG. 3, taken along the line IV-IV.

FIG. 5 is a plan view of a combustor-provided-reforming device serving as the reforming device according to a second embodiment of the present invention.

FIG. 6 is a plan view of a combustor-provided-reforming device serving as the reforming device according to a third embodiment of the present invention.

FIG. 7 is a sectional view of the combustor-provided-reforming device illustrated in FIG. 6.

FIG. 8 is a schematic diagram of a reforming system including a combustor-provided-reforming device serving as the reforming device according to a fourth embodiment of the present invention.

FIG. 9 is a plan view of the combustor-provided-reforming device illustrated in FIG. 8.

FIG. 10 is a plan view of a modification of the combustor-provided-reforming device illustrated in FIG. 2.

FIGS. 11A-11C are sectional views of the modification of the combustor-provided-reforming device illustrated in FIG. 3.

### DESCRIPTION OF EMBODIMENTS

The following will describe embodiments of the present invention with reference to figures. Identical or equivalent elements are denoted with the same symbols in the figures and redundant explanations are omitted.

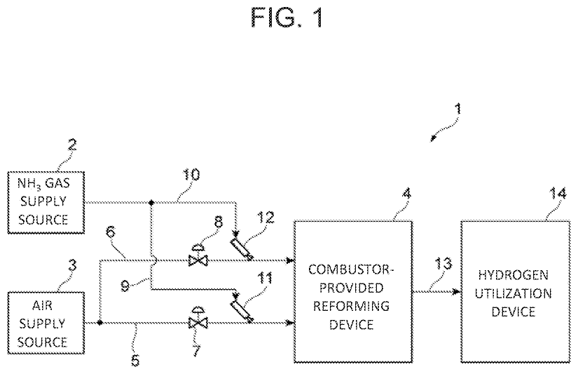

FIG. 1 is a schematic diagram of a reforming system including a combustor-provided-reforming device serving as the reforming device according to a first embodiment of the present invention. In FIG. 1, a reforming system 1 includes an ammonia gas supply source 2, an air supply source 3, and a combustor-provided-reforming device 4 according to the present embodiment.

The ammonia gas supply source 2 generates ammonia gas (NH₃ gas) serving as fuel gas. Although not particularly illustrated, the ammonia gas supply source 2 includes an ammonia tank for storing liquid ammonia, and a vaporizer for vaporizing the liquid ammonia into ammonia gas.

The air supply source 3 delivers air serving as oxidized gas. The air supply source 3 is an air blower, for example.

The combustor-provided-reforming device 4 is a device for reforming ammonia gas into reformed gas containing hydrogen by using heat generated by combusting ammonia gas. The combustor-provided-reforming device 4 will be described later.

The reforming system 1 includes air flow passages 5, 6, throttle valves 7, 8, ammonia gas passages 9, 10, and injectors 11, 12.

The air supply source 3 is connected to the combustor-provided-reforming device 4 via the air flow passages 5, 6. The air flow passages 5, 6 are passages through which the air generated in the air supply source 3 flows toward the combustor-provided-reforming device 4. The throttle valves 7, 8 are disposed in the air flow passages 5, 6, respectively. The throttle valves 7, 8 are flow rate control valves that are configured to control the flow rate of the air supplied to the combustor-provided-reforming device 4.

The ammonia gas supply source 2 is connected to the injectors 11, 12 via the ammonia gas passages 9, 10, respectively. The ammonia gas passages 9, 10 are passages through which the ammonia gas generated in the ammonia gas supply source 2 flows toward the injectors 11, 12. The injectors 11, 12 are fuel injection valves that inject the ammonia gas toward the combustor-provided-reforming device 4. The injector 11 injects the ammonia gas between the throttle valve 7 and the combustor-provided-reforming device 4 in the air flow passage 5, and the injector 12 injects the ammonia gas between the throttle valve 8 and the combustor-provided-reforming device 4 in the air flow passage 6.

The combustor-provided-reforming device 4 is connected to a hydrogen utilization device 14 via a reformed gas passage 13. The reformed gas passage 13 is a passage through which the reformed gas generated by the combustor-provided-reforming device 4 flows toward the hydrogen utilization device 14.

The hydrogen utilization device 14 is a device that utilizes hydrogen contained in the reformed gas. Examples of the hydrogen utilization device 14 include an ammonia engine or an ammonia gas turbine that uses ammonia gas as fuel, and a fuel cell that generates power by a chemical reaction of hydrogen with oxygen in air.

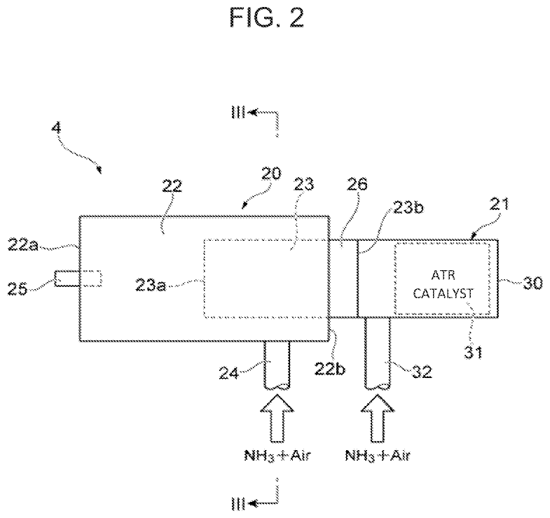

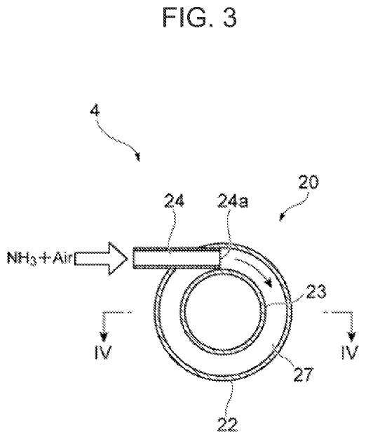

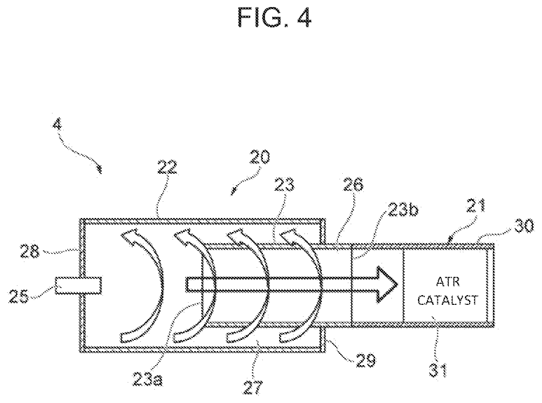

FIG. 2 is a plan view of the combustor-provided-reforming device 4. FIG. 3 is a sectional view of the combustor-provided-reforming device 4 of FIG. 2, taken along the line III-III. FIG. 4 is a sectional view of the combustor-provided-reforming device 4 of FIG. 3, taken along the line IV-IV. In FIGS. 2-4, the combustor-provided-reforming device 4 includes a combustor 20 and a reformer 21 disposed downstream of the combustor 20.

The combustor 20 is configured to combust the fuel gas to generate combustion gas. The combustor 20 includes an outer cylinder 22, an inner cylinder 23 disposed radially inward of the outer cylinder 22, a combustible gas pipe 24 that introduces the ammonia gas and the oxygen to the outer cylinder 22, and a spark plug 25 that ignites the ammonia gas in the outer cylinder 22.

The outer cylinder 22 and the inner cylinder 23 have a circular cylindrical shape. The combustor 20 has a double-pipe structure formed of the outer cylinder 22 and the inner cylinder 23. The outer cylinder 22, the inner cylinder 23, and the combustible gas pipe 24 are made of a metallic material, such as stainless steel, which is resistant to ammonia gas corrosion.

The inner cylinder 23 has a front end 23a that is located between a front end 22a of the outer cylinder 22 and a rear end 22b of the outer cylinder 22. The front end 23a of the inner cylinder 23 is an upstream end of the inner cylinder 23. The front end 22a of the outer cylinder 22 is an end that is located upstream of the inner cylinder 23. The front end 23a of the inner cylinder 23 is located at the axially center portion of the outer cylinder 22, for example. The front end 23a and a rear end 23b of the inner cylinder 23 are opened. The inner cylinder 23 has a protruding portion 26 that protrudes rearward (toward the reformer 21) from the rear end 22b of the outer cylinder 22. The inner cylinder 23 excluding the protruding portion 26 is accommodated in the outer cylinder 22.

A tubular combustible gas passage 27 through which the ammonia gas and the air introduced by the combustible gas pipe 24 flow toward the front end 22a of the outer cylinder 22 is formed between the inner peripheral surface of the outer cylinder 22 and the outer peripheral surface of the inner cylinder 23. The ammonia gas introduced by the combustible gas pipe 24 to the outer cylinder 22 serves as combustible gas.

The front end 22a of the outer cylinder 22 is provided with a front closure wall 28 that has a round shape and closes a space in the outer cylinder 22. That is, the front end 22a of the outer cylinder 22 is entirely closed by the front closure wall 28. The rear end 22b of the outer cylinder 22 is provided with a rear closure wall 29 that has a circular ring shape and closes the tubular combustible gas passage 27. That is, the rear end 22b of the outer cylinder 22 is closed by the rear closure wall 29, except for an area where the inner cylinder 23 is located.

The combustible gas pipe 24 is connected to the air flow passage 5. The combustible gas pipe 24 is located near the rear end 22b of the outer cylinder 22. The combustible gas pipe 24 serves as a combustible gas introduction part that introduces the ammonia gas and the air to the tubular combustible gas passage 27 in the outer cylinder 22. The combustible gas pipe 24 introduces the ammonia gas and the air to the tubular combustible gas passage 27 so that the ammonia gas and the air flow in the circumferential direction of the inner cylinder 23.

The combustible gas pipe 24 is inserted into and mounted to the outer cylinder 22. The combustible gas pipe 24 has a gas outlet 24a and is fixed to the outer cylinder 22 and the inner cylinder 23 at the gas outlet 24a. The combustible gas pipe 24 is disposed such that the axial direction of the combustible gas pipe 24 is perpendicular to the axial direction of the outer cylinder 22 and the inner cylinder 23. Accordingly, the ammonia gas and the air are introduced by the combustible gas pipe 24 to the outer cylinder 22 in the tangential direction of the inner peripheral surface of the outer cylinder 22.

The ammonia gas and the air are introduced to the tubular combustible gas passage 27 in the outer cylinder 22 and flow through the tubular combustible gas passage 27 along the inner cylinder 23 in the circumferential direction of the inner cylinder 23. This generates a swirl flow (tubular flow) of the ammonia gas and the air in the tubular combustible gas passage 27 (see FIG. 3).

The axial positional relationship of the inner cylinder 23 to the front closure wall 28 is defined so that the ammonia gas and the air swirl and flow to the front end 22a of the outer cylinder 22. That is, the distance between the front end 23a of the inner cylinder 23 and the front closure wall 28 is determined so that the swirl flow of the ammonia gas and the air is maintained to the front closure wall 28.

The spark plug 25 is fixed to the radially center portion of the front closure wall 28. The spark plug 25 serves as an igniter configured to ignite the ammonia gas that has reached the front closure wall 28.

The ammonia gas ignited by the spark plug 25 burns, so that combustion gas is generated. The combustion gas flows in the outer cylinder 22 toward the inner cylinder 23, and flows in the space in the inner cylinder 23 toward the reformer 21.

The reformer 21 includes a housing 30 having a circular cylindrical shape and connected to the rear end 23b of the inner cylinder 23, an autothermal reforming catalyst (ATR catalyst) 31 accommodated in the housing 30, and a reforming gas pipe 32 that introduces ammonia gas and air to the housing 30. The housing 30 and the reforming gas pipe 32 are made of a metallic material that is the same as the material of the inner cylinder 23.

The ATR catalyst 31 serves as a catalytic part that is heated by the heat of the combustion gas generated by the combustor 20 so as to combust the ammonia gas and reform ammonia gas by decomposing ammonia gas into hydrogen with the combustion heat (self-heat) of the ammonia gas. The ATR catalyst 31 has a honeycomb structure, for example.

For example, the ATR catalyst 31 combusts the ammonia gas in a temperature range of approximately 200° C. to 400° C. and reforms the ammonia gas in a range of temperature (e.g., approximately 250° C. to 500° C.) higher than the combustion temperature of the ammonia gas. Examples of the ATR catalyst 31 include a cobalt catalyst, a rhodium catalyst, a ruthenium catalyst, and a palladium catalyst.

The reforming gas pipe 32 is connected to the air flow passage 6. The reforming gas pipe 32 is mounted to the housing 30. The reforming gas pipe 32 introduces ammonia gas and air between the inner cylinder 23 and the ATR catalyst 31 in the housing 30. The reforming gas pipe 32 serves as a gas supply part through which the ammonia gas and the air are supplied to the ATR catalyst 31. The ammonia gas introduced by the reforming gas pipe 32 to the housing 30 serves as reforming gas. The ammonia gas introduced by the reforming gas pipe 32 to the housing 30 serves as cooling gas for cooling the combustion gas generated by the combustor 20.

The throttle valves 7, 8 and the injectors 11, 12 are opened when the reforming system 1 including the combustor-provided-reforming device 4 is activated. The air flows through the air flow passages 5, 6 toward the combustor-provided-reforming device 4, and the injectors 11, 12 inject the ammonia gas toward the combustor-provided-reforming device 4. Accordingly, mixed gas of the ammonia gas and the air is supplied to the combustor 20 and the reformer 21 of the combustor-provided-reforming device 4.

The mixed gas is introduced to the outer cylinder 22 through the combustible gas pipe 24 of the combustor 20, and swirls and flows in the tubular combustible gas passage 27 in the outer cylinder 22 toward the front end 22a of the outer cylinder 22. The spark plug 25 ignites the ammonia gas in the mixed gas when the swirl flow of the mixed gas reaches the front end 22a of the outer cylinder 22, so that the ignited ammonia gas forms a tubular flame and burns. Specifically, ammonia and oxygen in the air chemically react as the following formula to generate high-temperature combustion gas (exothermic reaction).

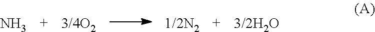

The combustion gas swirls and flows in the outer cylinder 22 toward the inner cylinder 23. The combustion gas is supplied to the reformer 21 through the space in the inner cylinder 23. The ambient-temperature mixed gas flows outside of the inner cylinder 23 and the high-temperature combustion gas flows inside of the inner cylinder 23. This causes a heat transfer from the high-temperature combustion gas flowing inside of the inner cylinder 23 to the ambient-temperature mixed gas flowing outside of the inner cylinder 23. This therefore decreases the temperature of the combustion gas, thereby suppressing a rise in the temperature of the inner cylinder 23 and heating the mixed gas with the heat of the combustion gas.

The ATR catalyst 31 is supplied with the mixed gas introduced to the housing 30 through the reforming gas pipe 32 of the reformer 21 and the combustion gas from the combustor 20, so that the ATR catalyst 31 is heated by the heat of the combustion gas and the temperature of the ATR catalyst 31 is therefore increased.

The combustion gas supplied from the combustor 20 is cooled by the ambient-temperature ammonia gas introduced to the housing 30 through the reforming gas pipe 32. This further decreases the temperature of the combustion gas supplied to the ATR catalyst 31.

The ignition by the spark plug 25 is stopped when the temperature of the ATR catalyst 31 increases to a combustion temperature, and the throttle valve 7 and the injector 11 are closed to stop the supply of the air and the ammonia gas to the combustor 20. Accordingly, the generation of the combustion gas by the combustor 20 is completed.

The ATR catalyst 31 combusts the ammonia gas when the temperature of the ATR catalyst 31 increases to the combustion temperature. This causes the exothermic reaction expressed in the formula (A), so that the self-heat of the ATR catalyst 31 further increases the temperature of the ATR catalyst 31.

The temperature of the ATR catalyst 31 increases to a reforming temperature, so that the ATR catalyst 31 reforms the ammonia gas. Specifically, ammonia decomposition reaction (endothermic reaction) is caused as the following formula to generate reformed gas containing hydrogen. The reformed gas is supplied to the hydrogen utilization device 14 through the reformed gas passage 13.

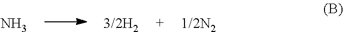

According to the present embodiment, the ammonia gas and the air are introduced by the combustible gas pipe 24 to the outer cylinder 22, and flow in the tubular combustible gas passage 27 between the outer cylinder 22 and the inner cylinder 23 toward the front end 22a of the outer cylinder 22. The ammonia gas and the air are introduced to the tubular combustible gas passage 27 so that the ammonia gas and the air flow in the circumferential direction of the inner cylinder 23, and the ammonia gas and the air therefore swirl and flow to the front end 22a of the outer cylinder 22. The ammonia gas is ignited by the spark plug 25 and burns, and the combustion gas flows in the inner cylinder 23 (inside of the inner cylinder 23). The heat of the combustion gas heats the ammonia gas flowing in the tubular combustible gas passage 27 (outside of the inner cylinder 23). The ammonia gas ignites in this state, so that the combustion of the ammonia gas is stabilized. Further, the ammonia gas and the air are supplied through the reforming gas pipe 32 to the ATR catalyst 31. The ATR catalyst 31 combusts and reforms the ammonia gas into the reformed gas containing hydrogen. In this way, the ammonia gas and the air flow in the tubular combustible gas passage 27 between the outer cylinder 22 and the inner cylinder 23 in the circumferential direction of the inner cylinder 23. Accordingly, this simple configuration of the combustor and the reforming device allows the generation of the swirl flow of the ammonia gas and the air. Furthermore, the heat of the combustion gas flowing inside of the inner cylinder 23 heats the ammonia gas and the air flowing outside of the inner cylinder 23. Accordingly, this simple configuration of the combustor and the reforming device allows the heating of the ammonia gas and the air.

In the present embodiment, the axial positional relationship of the inner cylinder 23 to the front closure wall 28 is defined so that the ammonia gas and the air, which have been introduced by the combustible gas pipe 24 to the tubular combustible gas passage 27, swirl and flow to the front closure wall 28. This allows the ammonia gas to ignite while swirling so as to form a tubular flame. Additionally, this promotes the ignition of the ammonia gas that has a slow combustion speed, thereby further stabilizing the combustion of the ammonia gas.

Furthermore, in the present embodiment, the combustion gas is supplied to the ATR catalyst 31 disposed downstream of the inner cylinder 23 together with the ammonia gas introduced to the housing 30 of the reformer 21, so that the temperature of the combustion gas supplied to the ATR catalyst 31 decreases.

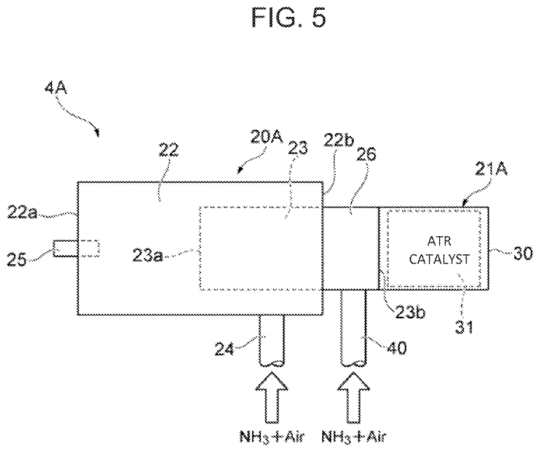

FIG. 5 is a plan view of a combustor-provided-reforming device serving as the reforming device according to a second embodiment of the present invention. In FIG. 5, a combustor-provided-reforming device 4A according to the present embodiment includes a combustor 20A and a reformer 21A disposed downstream of the combustor 20A.

The combustor 20A includes the outer cylinder 22, the inner cylinder 23, the combustible gas pipe 24, the spark plug 25, and a reforming gas pipe 40 that introduces ammonia gas and air to the inner cylinder 23.

The reforming gas pipe 40 is disposed at the protruding portion 26 of the inner cylinder 23. The reforming gas pipe 40 is connected to the air flow passage 6. The reforming gas pipe 40 serves as the reforming gas introduction part (another gas introduction part) that introduces ammonia gas and air to the inner cylinder 23. The ammonia gas introduced by the reforming gas pipe 40 to the inner cylinder 23 serves as cooling gas for cooling the combustion gas. The reforming gas pipe 40 serves as the gas supply part through which the ammonia gas and the air are supplied to the ATR catalyst 31.

The reformer 21A includes the housing 30 and the ATR catalyst 31. The reformer 21A does not include the reforming gas pipe 32.

In the present embodiment, the combustion gas is supplied to the ATR catalyst 31 disposed downstream of the inner cylinder 23 together with the ammonia gas introduced to the inner cylinder 23, so that the temperature of the combustion gas supplied to the ATR catalyst 31 through the inner cylinder 23 decreases. Furthermore, the combustion gas is supplied to the ATR catalyst 31 disposed downstream of the inner cylinder 23 together with the air introduced to the inner cylinder 23, so that the combustion of the ammonia gas is promoted.

In the present embodiment, the reforming gas pipe 40 is disposed at the protruding portion 26 of the inner cylinder 23. Accordingly, the ammonia gas is introduced to the inner cylinder 23 by this simple configuration.

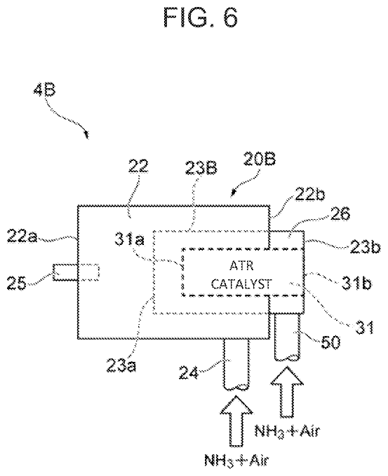

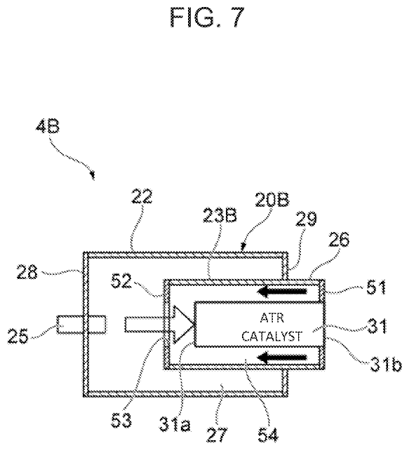

FIG. 6 is a plan view of a combustor-provided-reforming device serving as the reforming device according to a third embodiment of the present invention. FIG. 7 is a sectional view of the combustor-provided-reforming device illustrated in FIG. 6. In FIGS. 6 and 7, a combustor-provided-reforming device 4B according to the present embodiment includes a combustor 20B and the ATR catalyst 31.

The combustor 20B includes the outer cylinder 22, an inner cylinder 23B disposed radially inward of the outer cylinder 22, the combustible gas pipe 24, the spark plug 25, and a reforming gas pipe 50 that introduces ammonia gas and air to the inner cylinder 23B.

The inner cylinder 23B has the same configuration as that of the inner cylinder 23 except for the front end 23a and the rear end 23b. The inner cylinder 23B accommodates the ATR catalyst 31. The ATR catalyst 31 is smaller than the inner cylinder 23B in the axial direction and the radial direction. The ATR catalyst 31 has a front end 31a that is located between the front end 23a and the rear end 23b of the inner cylinder 23B. The front end 31a of the ATR catalyst 31 is the upstream end of the ATR catalyst 31. The ATR catalyst 31 has a rear end 31b that is located at the same position as that of the rear end 23b of the inner cylinder 23B.

A tubular reforming gas passage 54 through which the ammonia gas and the air introduced by the reforming gas pipe 50 flow toward the front end 23a of the inner cylinder 23B is formed between the inner peripheral surface of the inner cylinder 23B and the ATR catalyst 31.

The rear end 23b of the inner cylinder 23B is provided with a closure wall 51 that has a circular ring shape and closes the tubular reforming gas passage 54. That is, the rear end 23b of the inner cylinder 23B is closed by the closure wall 51, except for the ATR catalyst 31.

The inner cylinder 23B is provided with a flange wall 52 that is disposed at the front end 23a and projects radially inward of the inner cylinder 23B. The flange wall 52 bounces the ammonia gas and the air flowing in the tubular reforming gas passage 54 toward the front end 31a of the ATR catalyst 31. The size of the flange wall 52 is the same as that of the closure wall 51, for example. The flange wall 52 has an opening 53 through which the combustion gas generated by the combustor 20B flows toward the ATR catalyst 31.

The reforming gas pipe 50 is disposed at the protruding portion 26 of the inner cylinder 23B. The reforming gas pipe 50 is connected to the air flow passage 6. The reforming gas pipe 50 serves as the reforming gas introduction part (another gas introduction part) that introduces the ammonia gas to the inner cylinder 23B. The ammonia gas introduced by the reforming gas pipe 50 to the inner cylinder 23B also serves as cooling gas for cooling the combustion gas. The reforming gas pipe 50 may introduce the ammonia gas to the inner cylinder 23B in the radial direction of the inner cylinder 23B (as illustrated) or may introduce the ammonia gas to the inner cylinder 23B in the axial direction of the inner cylinder 23B. The reforming gas pipe 50 and the tubular reforming gas passage 54 serve as the gas supply part through which the ammonia gas and the air are supplied to the ATR catalyst 31.

In the combustor-provided-reforming device 4B, the ammonia gas and the air are introduced by the combustible gas pipe 24 to the outer cylinder 22. The ammonia gas is ignited by the spark plug 25 and burns, so that the combustion gas is supplied to the ATR catalyst 31 through the opening 53 of the inner cylinder 23B.

The ammonia gas and the air are introduced by the reforming gas pipe 50 to the inner cylinder 23B and flow in the tubular reforming gas passage 54 toward the front end 23a of the inner cylinder 23B. The ammonia gas and the air are bounced by the flange wall 52 and supplied to the ATR catalyst 31. The ATR catalyst 31 combusts and reforms the ammonia gas.

According to the present embodiment, the ATR catalyst 31 is accommodated in the inner cylinder 23B. Accordingly, the combustor-provided-reforming device 4B is reduced in size in the axial direction and therefore downsized.

According to the present embodiment, the ammonia gas and the air introduced to the inner cylinder 23B flow in the tubular reforming gas passage 54 between the inner cylinder 23B and the ATR catalyst 31 toward the front end 23a of the inner cylinder 23B, and are supplied to the ATR catalyst 31. The ammonia gas and the air flowing in the inner cylinder 23B are heated by the heat of the ATR catalyst 31 and supplied to the ATR catalyst 31. This allows the ATR catalyst 31 to effectively combust and reform the ammonia gas.

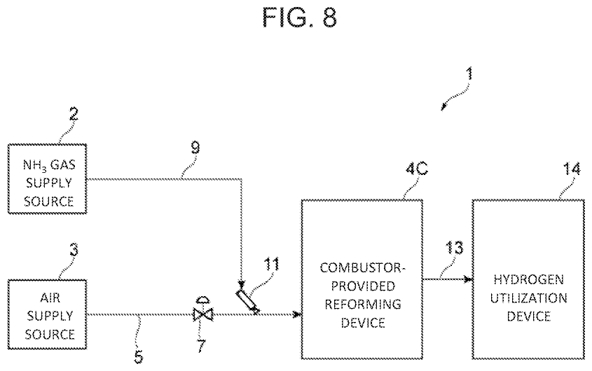

FIG. 8 is a schematic diagram of a reforming system including a combustor-provided-reforming device serving as the reforming device according to a fourth embodiment of the present invention. In FIG. 8, the reforming system 1 includes the ammonia gas supply source 2, the air supply source 3, a combustor-provided-reforming device 4C according to the present embodiment, the air flow passage 5, the throttle valve 7, the ammonia gas passage 9, and the injector 11. The reforming system 1 does not include the air flow passages 6, the throttle valve 8, the ammonia gas passage 10, and the injector 12 according to the first to third embodiments.

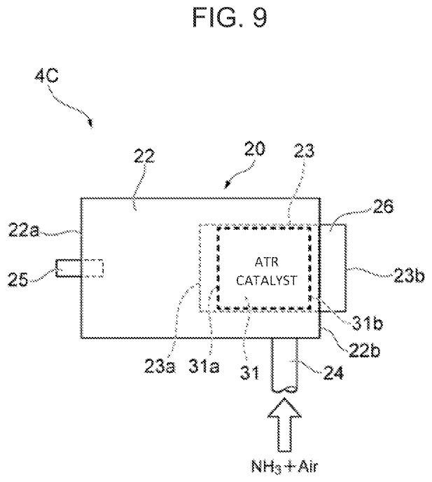

FIG. 9 is a plan view of the combustor-provided-reforming device 4C. In FIG. 9, the combustor-provided-reforming device 4C includes the combustor 20 and the ATR catalyst 31. The combustor-provided-reforming device 4C does not include the reforming gas pipe 50. The combustible gas pipe 24 also serves as the gas supply part through which ammonia gas and air are supplied to the ATR catalyst 31.

The ATR catalyst 31 is accommodated in the inner cylinder 23 of the combustor 20. The whole of the ATR catalyst 31 may be disposed in the outer cylinder 22 of the combustor 20 (as illustrated), or a part of the ATR catalyst 31 may be disposed in the protruding portion 26 of the inner cylinder 23.

In the combustor-provided-reforming device 4C, the ammonia gas and the air are introduced by the combustible gas pipe 24 to the outer cylinder 22. Part of the ammonia gas and the air reaches the spark plug 25, and the ammonia gas is ignited and burns. Accordingly, the combustion gas is supplied to the ATR catalyst 31 in the inner cylinder 23. The rest of the ammonia gas and the air is supplied to the ATR catalyst 31 in the inner cylinder 23. The ATR catalyst 31 combusts and reforms the ammonia gas.

In the present embodiment, the configuration of the combustor-provided-reforming device 4C and the configuration of the reforming system 1 are simplified.

The present invention is not limited to the above-mentioned embodiments. For example, in the above-mentioned embodiments, the combustible gas pipe 24 of the combustor 20 is disposed such that the axial direction of the combustible gas pipe 24 is perpendicular to the axial direction of the outer cylinder 22 and the inner cylinder 23, but the present invention is not limited thereto.

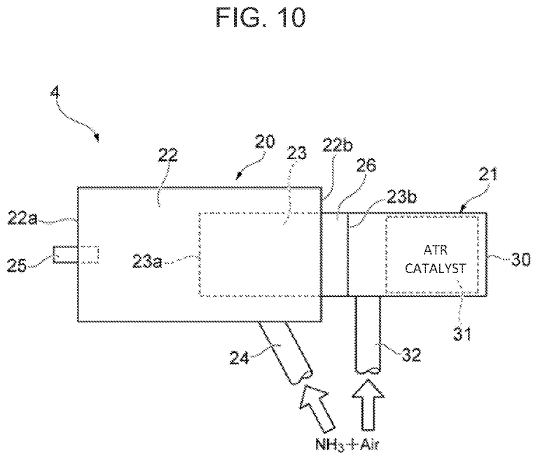

The combustible gas pipe 24 may be disposed as illustrated in FIG. 10 such that the axial direction of the combustible gas pipe 24 is inclined with respect to the axial direction of the outer cylinder 22 and the inner cylinder 23. The combustible gas pipe 24 is disposed such that the gas outlet 24a (see FIG. 3) faces the front end 22a of the outer cylinder 22. Accordingly, the ammonia gas and the air introduced by the combustible gas pipe 24 to the outer cylinder 22 easily flow toward the front end 22a of the outer cylinder 22.

Furthermore, the axial direction of the reforming gas pipes 32, 40, 50 that introduce the ammonia gas and the air supplied to the ATR catalyst 31 may be inclined with respect to the axial direction of the outer cylinder 22 and the inner cylinder 23.

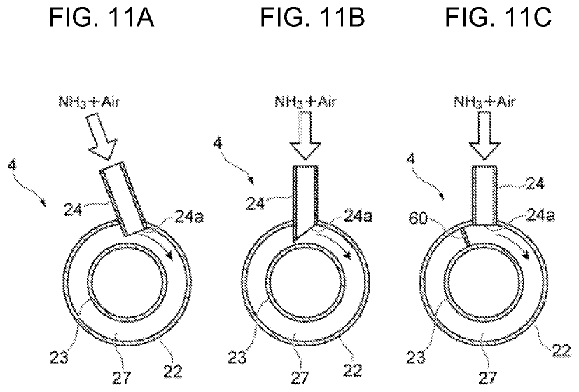

In the above-mentioned embodiments, the combustible gas pipe 24 is disposed such that the ammonia gas and the air are introduced to the outer cylinder 22 in the tangential direction of the inner peripheral surface of the outer cylinder 22, but the present invention is not limited thereto. The combustible gas pipe 24 may be disposed as illustrated in FIGS. 11A-11C such that the ammonia gas and the air are introduced to the outer cylinder 22 in a direction different from the tangential direction of the inner peripheral surface of the outer cylinder 22.

For example, as illustrated in FIG. 11A, the axial direction of the combustible gas pipe 24 may be inclined with respect to the radial direction of the outer cylinder 22 and the inner cylinder 23. In this configuration, the ammonia gas and the air introduced by the combustible gas pipe 24 to the outer cylinder 22 swirl in the tubular combustible gas passage 27 in the inclined direction of the combustible gas pipe 24.

Furthermore, as illustrated in FIG. 11B, the gas outlet 24a of the combustible gas pipe 24 may have a tapered shape. The axial direction of the combustible gas pipe 24 corresponds to the radial direction of the outer cylinder 22 and the inner cylinder 23. In this configuration, the ammonia gas and the air introduced by the combustible gas pipe 24 to the outer cylinder 22 swirl in the tubular combustible gas passage 27 to the side corresponding to the gas outlet 24a.

Furthermore, as illustrated in FIG. 11C, a wall 60 may be disposed between the outer cylinder 22 and the inner cylinder 23 in the vicinity of the gas outlet 24a of the combustible gas pipe 24. The axial direction of the combustible gas pipe 24 corresponds to the radial direction of the outer cylinder 22 and the inner cylinder 23. In this configuration, the ammonia gas and the air introduced by the combustible gas pipe 24 to the outer cylinder 22 swirl in the tubular combustible gas passage 27 in a direction away from the wall 60.

In this way, the ammonia gas and the air flow in the tubular combustible gas passage 27 in the circumferential direction of the inner cylinder 23 even if the ammonia gas and the air are introduced to the outer cylinder 22 in a direction different from the tangential direction of the inner peripheral surface of the outer cylinder 22, so that the swirl flow of the ammonia gas and the air is generated.

In the above-mentioned embodiments, the combustible gas pipe 24 introduces the mixed gas of the ammonia gas and the air to the outer cylinder 22 so that the mixed gas of the ammonia gas and the air flows in the circumferential direction the inner cylinder 23, but the present invention is not limited thereto. For example, an ammonia gas pipe that introduces the ammonia gas to the outer cylinder 22 so that the ammonia gas flows in the circumferential direction of the inner cylinder 23 and an air pipe that introduces the air to the outer cylinder 22 so that the air flows in the circumferential direction of the inner cylinder 23 may be disposed separately. In this configuration, the ammonia gas pipe and the air pipe form the combustible gas introduction part that introduces the ammonia gas and the air to the outer cylinder 22. This is also applied to the reforming gas pipes 32, 40, 50 that introduce the ammonia gas and the air to the ATR catalyst 31.

In the above-mentioned embodiments, the inner cylinder 23 has the protruding portion 26 that protrudes from the rear end 22b of the outer cylinder 22, but the present invention is not limited thereto. For example, in the first embodiment and the fourth embodiment, the inner cylinder 23 may be provided without the protruding portion 26 and the whole of the inner cylinder 23 may be accommodated in the outer cylinder 22. This allows the combustor-provided-reforming devices 4, 4C to be reduced in size in the axial direction.

In the above-mentioned embodiments, the combustor-provided-reforming devices 4-4C include the ATR catalyst 31 for combusting the ammonia gas and decomposing the ammonia gas into hydrogen, but the present invention is not limited thereto. The combustor-provided-reforming devices 4-4C may include a combustion catalyst for combusting the ammonia gas and a reformer catalyst for decomposing the ammonia gas into hydrogen separately.

In the above-mentioned embodiments, the combustors 20-20B are applied to the reforming device of the reforming system 1, but the combustor of the present invention may be applicable to a device or system other than the reforming device. For example, in an exhaust system, introducing the air to the inner cylinder 23 of the combustor 20A as described in the second embodiment allows combustion of unburned ammonia flowing in the inner cylinder 23 and reduction in NOx (nitrogen oxide) generation.

Ammonia gas is used as fuel gas in the above-mentioned embodiments, but the present invention is applicable to a combustor and a reforming device that use gas, such as hydrocarbon gas, as fuel gas.

Air is used as oxidized gas in the above-mentioned embodiments, but the present invention is applicable to a combustor and a reforming device that use oxygen as oxidized gas.

### REFERENCE SIGNS LIST

4, 4A, 4B, 4C Combustor-provided-reforming device (reforming device)
20, 20A, 20B Combustor
22 Outer cylinder
22a Front end
22b Rear end
23, 23B Inner cylinder
23a Front end
23b Rear end
24 Combustible gas pipe (combustible gas introduction part, gas supply part)
25 Spark plug (igniter)
26 Protruding portion
27 Tubular combustible gas passage (tubular gas passage)
28 Front closure wall
29 Rear closure wall
31 ATR catalyst (catalytic part)
40 Reforming gas pipe (reforming gas introduction part, another gas introduction part, gas supply part)
50 Reforming gas pipe (reforming gas introduction part, another gas introduction part, gas supply part)
54 Tubular reforming gas passage (gas supply part)

1-4. (canceled)

5. A reforming device for reforming fuel gas into reformed gas containing hydrogen by using heat generated by combusting the fuel gas, the reforming device comprising:
an outer cylinder;
an inner cylinder disposed radially inward of the outer cylinder;
a combustible gas introduction part introducing the fuel gas and oxidized gas to the outer cylinder;
an igniter configured to ignite the fuel gas introduced to the outer cylinder;
a catalytic part heated by the heat of combustion gas generated by ignition of the fuel gas by the igniter so as to combust the fuel gas and reform the fuel gas; and
a gas supply part through which the fuel gas and the oxidized gas are supplied to the catalytic part, wherein
the inner cylinder has a front end that is located between a front end of the outer cylinder and a rear end of the outer cylinder,
the front end and a rear end of the inner cylinder are opened,
a tubular combustible gas passage through which the fuel gas and the oxidized gas introduced by the combustible gas introduction part flow toward the front end of the outer cylinder is formed between the outer cylinder and the inner cylinder,
the front end of the outer cylinder is provided with a front closure wall that closes a space in the outer cylinder,
the rear end of the outer cylinder is provided with a rear closure wall that closes the tubular combustible gas passage,
the igniter is fixed to the front closure wall, and
the combustible gas introduction part is located near the rear end of the outer cylinder and introduces the fuel gas and the oxidized gas to the tubular combustible gas passage so that the fuel gas and the oxidized gas flow in a circumferential direction of the inner cylinder.

6. The reforming device according to claim 5, wherein an axial positional relationship of the inner cylinder to the front closure wall is defined so that the fuel gas and the oxidized gas introduced by the combustible gas introduction part to the tubular combustible gas passage swirl and flow to the front closure wall.

7. The reforming device according to claim 5, wherein the catalytic part is accommodated in the inner cylinder.

8. The reforming device according to claim 7, wherein the gas supply part includes a reforming gas introduction part introducing the fuel gas and the oxidized gas to the inner cylinder and a tubular reforming gas passage which is formed between the inner cylinder and the catalytic part and through which the fuel gas and the oxidized gas introduced by the reforming gas introduction part flow toward the front end of the inner cylinder.

9. The reforming device according to claim 8, wherein
the inner cylinder has a protruding portion that protrudes from the rear end of the outer cylinder, and
the reforming gas introduction part is disposed at the protruding portion.
